(19) United States
(12) Patent Application Publication
(10) Pub. No.: US 2016/0144772 A1
(43) Pub. Date: May 26, 2016

(54) HEADLIGHT FOR A MOTOR VEHICLE

(71) Applicant: GM GLOBAL TECHNOLOGY OPERATIONS LLC, Detroit, MI (US)

(72) Inventors: Frank LANGKABEL, Rüsselsheim (DE); Ingolf SCHNEIDER, Rüsselsheim (DE); Heiko ECKERT, Bingen-Büdesheim (DE); Serkan PROEPPER, Weiler bei Bingen (DE); Ralph SCHNEIDER, Riedstadt (DE); Gregor KRIEG, Hanau (DE); Michael BACH, Wiesbaden (DE); Thorsten BOG, Trebur - Astheim (DE)

(73) Assignee: GM GLOBAL TECHNOLOGY OPERATIONS LLC, Detroit, MI (US)

(21) Appl. No.: 14/949,420

(22) Filed: Nov. 23, 2015

(30) Foreign Application Priority Data
Nov. 24, 2014 (DE) 102014017319.4

(51) Int. Cl. B60Q 1/26; F21V 3/04; F21S 8/10

(52) U.S. Cl. CPC B60Q 1/2607; F21S 48/215; F21S 48/2212; F21V 3/049; F21Y 2101/02

(57) ABSTRACT

A headlight for a motor vehicle with a light-emitting surface, which when viewed from the direction of a main beam is divided into a main area that emits the main beam and two elongated edge areas. A first edge area serves as a turn signal and is spaced apart from the main area by the second edge area. The second edge area serves as the daytime running light.

### CROSS-REFERENCE TO RELATED APPLICATION

This application claims priority to German Patent Application No. 102014017319.4, filed Nov. 24, 2014, which is incorporated herein by reference in its entirety.

### TECHNICAL FIELD

The present disclosure pertains to a headlight for a motor vehicle with turn signal and daytime running light function.

### BACKGROUND

Provisions by state and/or federal regulations generally govern the requirements placed on lighting of motor vehicles. For example, it must be ensured that a turn signal can be seen even on low beams. For this reason, at least some regulations require a minimum luminosity for turn signals, depending on the distance between the turn signal and low beams. The dimmer the turn signal (i.e., with a lower luminosity), the greater this minimum distance, and therefore the more cumbersome and difficult it is to integrate a headlight that combines low beams and turn signals into a vehicle front. While brighter turn signals (i.e., with a higher luminosity) can be arranged at less of a distance from the low beams, they are also more expensive.

### SUMMARY

The present disclosure provides a headlight that permits the use of a cost-effective turn signal while having compact dimensions. In an embodiment of the present disclosure, a headlight for a motor vehicle includes a light-emitting surface, which when viewed from the direction of a main beam is divided into a main area that emits the main beam and two elongated edge areas. The first edge area serves as a turn signal and is spaced apart from the main area by the second edge area. The second edge area serves as the daytime running light. The main area can be divided into a high beam and a low beam area. The first edge area can be switchable between operation as a turn signal and operation as a daytime running light. As a consequence, the first and second edge areas can together serve as a readily visible daytime running light with the turn signal turned off.

The first edge area can have allocated to it a lamp that glows white and yellow. If the white lamp is turned on, the first edge area serves as a daytime running light. If the yellow lamp is turned on, the first edge area serves as a turn signal. Alternatively, the first edge area can have allocated to it several lamps, the light from which can be overlaid to produce white light. It should be possible to reduce the luminosity of at least one of the lamps, so that yellow light can also be generated instead of the white light. The white light can also be generated by a red, a green and a blue lamp. Different-colored lamps of the same type can also be used to generate the daytime running light in the second edge area. When the lamps of the first and second edge areas are each combined into identically designed assemblies, it helps provide a cost-effective structure for the headlight.

Several lamps, in particular LEDs, can be distributed along the edge area so that the edge area emits light over its entire length. It is easier for at least one of the edge areas to exhibit an elongated scattering body, and for at least one lamp to be arranged at one end of the scattering body, so as to radiate through the latter, and allow it to emit the introduced light distributed over its length.

Since the scattering body emits light distributed over its length, the light flux in the scattering body gets progressively weaker with increasing distance from the lamp. This can cause the visible brightness of the scattering body to also taper from one end to the other. To diminish the susceptibility to such a decrease, at least one of the edge areas of the headlight can incorporate scattering bodies extending away from a center in different directions, in which at least one lamp is situated at one end of each scattering body so as to radiate through the latter.

The simple wiring makes it possible to arrange the lamps of both scattering bodies in the center. A single lamp situated in the center can also radiate through both scattering bodies. The headlight can also exhibit a receptacle, in which is mounted an assembly with at least one scattering body and allocated lamps. The lamp can encompass at least one LED.

At least one of the edge areas can be switched to the parking light operating mode. It is sufficient for the light-emitting surface of the parking light to have a brightness lower than that of the daytime running light. If several white lamps are allocated to the edge area, at least one of these lamps can be turned off, so that a switch can be made from the daytime running light to the parking light operating mode.

Alternatively, the headlight can exhibit an adjusting unit for dimming the white glowing lamp or the lamps that together generate the white light, so as to switch the allocated edge area to the parking light operating mode.

The second edge area can be narrower in the vicinity of the high beam area than in the vicinity of the low beam area. Since only a minimum distance from the low beam is prescribed for turn signals with a low luminosity, the light-emitting surface of the headlight can in this way be made compact.

In order to illuminate an edge area that narrows toward the high beam area, the scattering body can taper from one end to the other, and the lamp can be arranged at the wider end. By tapering the scattering body as opposed to having the scattering body be uniformly thick, the reduction in the brightness of the scattering body with increasing distance from the lamp can also be made less conspicuous.

### BRIEF DESCRIPTION OF THE DRAWINGS

The present disclosure will hereinafter be described in conjunction with the following drawing figures, wherein like numerals denote like elements.

FIG. 1 is a schematic view of a headlight:

FIG. 2 is a section through the headlight along the sectional plane II-II on FIG. 1;

FIG. 3 is a section through the headlight along the sectional plane III-III on FIG. 1; and

FIG. 4 is an embodiment of the scattering body for a second variant.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

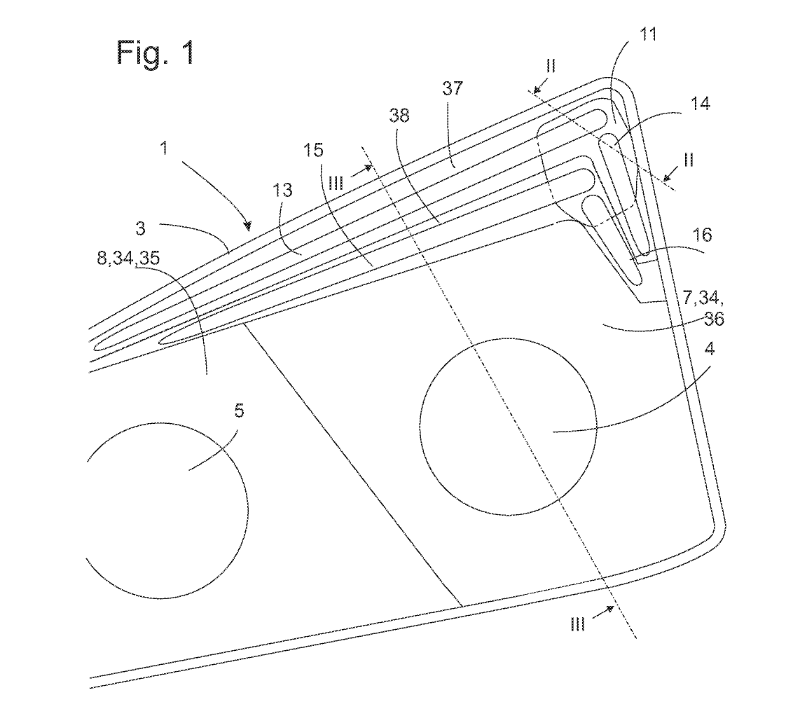

FIG. 1 shows a headlight 1 for a motor vehicle in a schematic view. A light-emitting surface of the headlight 1 is divided into areas 35, 36, 37, and 38. Area 35 is referred to as the low beam area and contains a lamp 4 and a reflector 7 that bundles the light of the lamp 4 into a ray of low beam light. Area 36 is referred to as the high beam area contains a lamp 5 and a reflector 8, which bundles the light of the lamp 5 into a ray of high beam light. The high and low beam light rays are only emitted in slightly varying directions, and can both be construed as a main beam of headlight 1, which expands in the opposite direction as viewed toward the headlamp 1 on FIG. 1. Accordingly, the two areas 35, 36 can together be construed as a main area 34 of the headlight 1.

Area 37, referred to herein as a the first edge area, is hook-shaped, with an upper leg that runs along an upper edge of the headlight and a lateral leg, which runs along the upper part of a lateral edge of the headlight that adjoins a fender of the vehicle. The first edge area 35 contains two elongated scattering bodies 13, 14, of which one extends in the upper leg, and the other extends in the lateral leg, as well as a reflector 30 that fills out the entire edge area 37. Area 38, referred to herein as the second edge area, is included between the first edge area 37 and main area 34. The second edge area 38 is also hook-shaped, and each of its two legs incorporates elongated scattering bodies 15, 16 and a reflector 31 that extends behind the scattering bodies 15, 16.

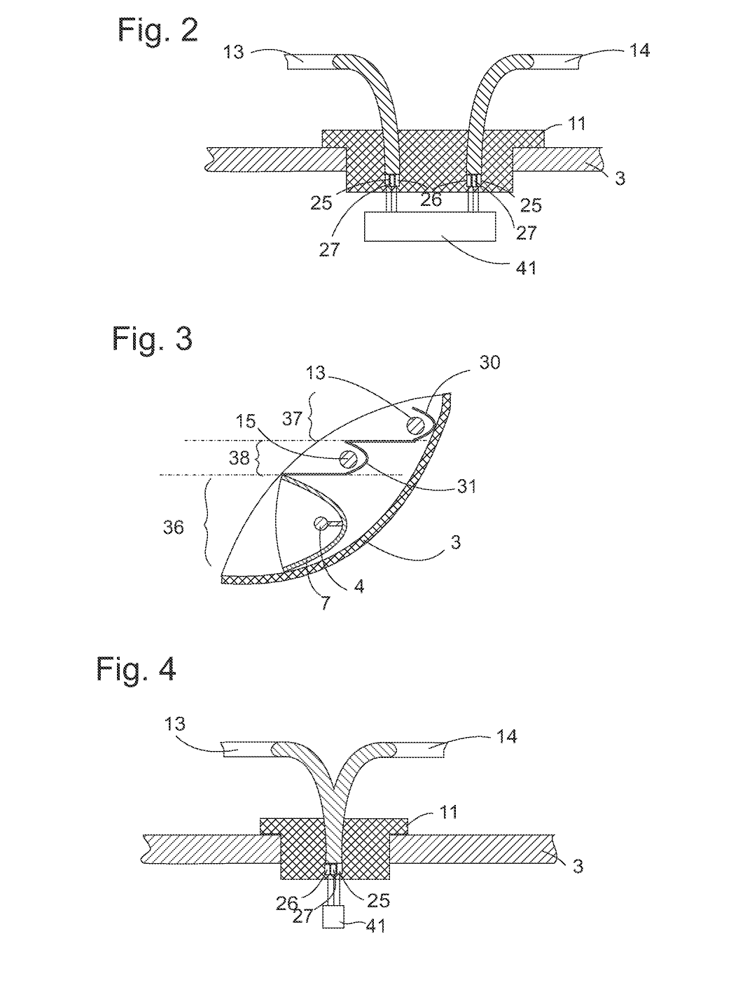

FIG. 2 shows a section along the sectional plane II-II on FIG. 1. The ends of the scattering bodies 13, 14 are inserted into recesses in a socket 11. Three lamps 25, 26, 27 are secured to the floor of each recess in such a way as to radiate through the scattering body 13 or 14 from its inserted end. The scattering bodies 13, 14 continuously emit the introduced light over their length. The scattering bodies 15, 16 are inserted in the same way as scattering bodies 13, 14 into recesses of the socket 11 fitted with lamps 25, 26, 27.

Alternatively, two structurally identical sockets could also be mounted in the headlight 1, of which one accommodates the scattering bodies 13, 14 of the first edge area 37, and the other accommodates the scattering bodies 15, 16 of the second edge area 38. An electronic adjusting unit 41 controls the lamps 25, 26, 27 of the first and second edge areas.

The scattering bodies 13, 14, 15, and 16 shown on FIG. 1 taper from the end that is accommodated in the socket 11 toward the other, free end. Since the scattering bodies 13, 14, 15, 16 emit light along their length; the light flux in the scattering bodies diminishes from the respective socketed end to the free end. Given a scattering body with a constant cross section, this would result in a brightness that diminishes toward the free end. Since the taper also causes the light-emitting surface of the scattering bodies to become narrower toward the free end, the reduction in brightness can be diminished, or the brightness can even be kept constant.

FIG. 3 shows a section through the headlight along the sectional plane III-III on FIG. 1. The low beam area 35 and edge areas 37, 38 are staggered in the longitudinal direction of the vehicle. Setting back the second edge area 38 behind the underlying low beam area 36 and the first edge area 37 behind the underlying second edge area 38 imparts a streamlined, arrowhead shape to the headlight 1.

In the embodiment on FIG. 3, the scattering bodies 13, 15 each have a round cross section, and the reflectors 30, 31 are spaced apart from the scattering bodies 13, 15. Since a sharp bundling of the kind used for the high and low beams is neither required nor desired for the light emitted by the edge areas 37, 38, the reflectors 30, 31 in a first variant can be replaced by a reflecting layer applied directly to a surface of the scattering bodies 13, 14, 15, 16 that directly faces the interior of the headlight 1.

FIG. 4 shows the two scattering bodies 13, 14 for a second variant in a section along a sectional plane similar to FIG. 2. The ends of the two scattering bodies 13, 14 facing the lamps are here merged together and accommodated in a shared recess of the socket 11. The lamps 25, 26, 27 secured in this recess supply both scattering bodies 13, 14. This makes it possible to economize on lamps by comparison to the embodiment on FIG. 2. The scattering bodies 15, 16 can also be designed according to this second variant.

In a first embodiment, each scattering body 13, 14, 15, 16 has a respective LED that is red for lamp 25, green for lamp 26, and blue for lamp 27. The color of the LEDs is selected in such a way that their light overlaps to yield white light at full luminosity. To operate the edge area 38 as a daytime running light, the adjusting unit 41 turns on the LED's 25, 26, 27 on the scattering bodies 15, 16, so that the edge area 38 emits white light. The lamps on the scattering bodies 13, 14 remain turned off.

For indicator signal operation, the adjusting unit 41 leaves the blue LED 27 turned off, and intermittently operates the red LED 25 and green LED 26. In this way, the edge area 37 emits a yellow blinking light. The LED's in the edge area 38 remain turned off, thereby ensuring a required distance between the blinking light and the low beam area 36. In a further development, the hues of the yellow blinking light can be finely adjusted by turning on the blue LED at a slight luminosity. The required slight luminosity can be achieved by dimming via pulse width modulation or phase angle control. The LEDs of the edge area 38 can be correspondingly dimmed together, so as to generate a weaker parking light instead of the daytime running light.

In a second embodiment, the daytime running light is generated by having the control unit operate the LEDs of both edge areas 37, 38 at full intensity. In order to enable blinking as described above, the generation of daytime running light is occasionally interrupted at least in the edge area 37. The parking light is especially easy to realize in this embodiment by turning off one of the two edge areas 37, 38, while the LED's 25, 26, 27 in the other one remain turned on at the same output as in the daytime light operating mode.

In a third embodiment, two LEDs, one white and one yellow, are arranged on each scattering body of the edge area 37, as opposed to the illustration on FIGS. 2 and 4. While two white LEDs can be provided on the scattering bodies of the edge area 38, the installation site for an LED can also remain unoccupied. The white LEDs in both edge areas 37, 38 can be turned on for daytime light. The white LEDs of the edge area 37 are turned off and the yellow ones are intermittently operated for blinking purposes. In this embodiment, parking light can be realized by only operating the respective white LED's of one of the two edge areas 37, 38. The adjusting unit 41 does not have to have a dimming function.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A headlight for a motor vehicle comprising a light-emitting surface which when viewed from the direction of a main beam is divided into a main area and an edge area including a first edge area spaced apart from the main area by a second edge area, wherein the main area is configured to emit the main beam, the edge area is configured to emit at least one of a turn signal and a daytime running light.

15. The headlight according to claim 14, wherein the first edge area is operable to be switched between a turn signal operating mode and a daytime running light operating mode.

16. The headlight according to claim 15, wherein at least one of the first and second edge areas is operable in a parking light operating mode.

17. The headlight according to claim 15, wherein the first edge area comprises a white light element and a yellow light element.

18. The headlight according to claim 15, wherein the first edge area comprises a plurality of light elements configured to overlay light emitted thereby to produce white light, wherein the luminosity of at least one of the plurality of light element can be reduced, so as to overlay the light from the remaining plurality of light elements to produce yellow light.

19. The headlight according to claim 18, further comprising an elongated scattering body in at least one of the first and second edge areas, and at least one of the plurality of light elements is situated at the end of the scattering body so as to radiate through the latter.

20. The headlight according to claim 19, wherein at least one of the first and second edge areas comprising two scattering bodies extending away from a center in different directions.

21. The headlight according to claim 19, wherein the scattering body tapers from a first end toward a second end, and the light element is arranged at the first end.

22. The headlight according to claim 19, further comprising an assembly including the scattering body and the plurality of light element, wherein the assembly is mounted in a receptacle.

23. The headlight according to claim 19, wherein the plurality of light elements comprise at least one LED.

24. The headlight according to claim 18, further comprising an adjusting unit operable to dim the plurality of light elements generating white light so as to switch the edge area to operate in the parking light operating mode.

25. The headlight according to claim 14, wherein the main area comprises a high beam area and a low beam area.

26. The headlight according to claim 26, wherein the second edge area is wider in the vicinity of the low beam area than in the vicinity of the high beam area.
